(19) United States
(12) Patent Application Publication
(10) Pub. No.: US 2007/0236849 A1
(43) Pub. Date: Oct. 11, 2007

(54) LEADLESS INTEGRATED CIRCUIT PROTECTION DEVICE

(75) Inventors: Richard James Bono, Brownsville, TX (US); Juan de Dios Martinez, Brownsville, TX (US); Stephen J. Whitney, Lake Zurick, IL (US)

Correspondence Address: BELL, BOYD & LLOYD LLP, P.O. BOX 1135, CHICAGO, IL, 60690, US

(73) Assignee: Littelfuse, Inc., Des Plaines, IL (US)

(21) Appl. No.: 11/278,915

(22) Filed: Apr. 6, 2006

(51) Int. Cl. H02H 5/04

(52) U.S. Cl. 361/104

(57) ABSTRACT

A circuit protection device includes a fuse placed in electrical communication with first and second conductors. An overvoltage protection component is placed in electrical communication with the first conductor and a third conductor. An insulative housing encloses the fuse, overvoltage protection component and portions of the first, second and third conductors. The first and second conductors include first and second terminal portions, respectively, that extend through the housing and reside at least substantially flush with an outer surface of the housing.

### BACKGROUND

Certain electrical and electronic circuits require overcurrent protection and overvoltage protection. In the past, the overcurrent and overvoltage protection has been obtained through at least two discrete devices. Each device provides protection for a specific application. For example, a discrete overcurrent device is used to provide protection during an overcurrent situation. In addition, a discrete voltage suppressor is used to provide protection during an excessive voltage. The two discrete devices are interconnected through printed circuit board tracing. Valuable space of the printed circuit board is consumed by the separate footprints of the separate components. Circuit board designers constantly look for ways to conserve board space. Reducing the overall board space needed for overcurrent and overvoltage protection would be one way to conserve board space.

Also, electrical coordination problems arise with the discrete devices, creating difficulties in assuring that the voltage suppressor and overcurrent protector each perform their job properly. Coordination between devices is important to ensure that the protection components operate under specified overcurrent and overvoltage conditions. One reason that coordination between the discrete devices can be difficult is that the devices are often times provided by different manufacturers. Specified tolerances for discrete devices of different manufacturers may vary, resulting in poor coordination between the discrete devices. The burden is placed on the circuit board engineer to assure the compatibility of the discrete devices. And determining proper electrical coordination between the devices requires an evaluation of the performance characteristics of each device (e.g., I²t energy curves, etc.) to ensure that protection against excessive voltages and currents will be provided as desired.

Integrating overcurrent and overvoltage protection into a single device presents certain challenges. For example, a particular application may have specific protection requirements and necessitate a particular terminal layout. Using discrete devices enables the engineer to locate each device where it is needed. An integrated device however needs to be configured for the dual application. Also, an integrated overcurrent and overvoltage device should not sacrifice the performance expected of discrete devices for the sake of saving space and reducing manufacturing cost.

A need therefore exists for an integrated overcurrent and overvoltage device to conserve board space, which is readily configurable for varying applications and ratings, and which performs at a level commensurate with that of discrete overcurrent and overvoltage devices.

### SUMMARY

Described below are examples of leadless circuit protection devices. The circuit protection devices each include a plurality of at least one type of circuit protection. In one example illustrated below, the leadless device provides overcurrent and overvoltage protection in the form of a fuse in combination with multiple SIDACtor® overvoltage protection components. The illustrated device is configured to protect four signal lines, such as two twisted pair lines extending for example to a telecom connector. Here, the leadless device is configured to place each of its fuses in series with a different signal line on a printed circuit board (“PCB”).

Each of the fuses in one example includes an insulative body and two end caps attached to the body. A fuse element is held by the body and is connected electrically to the end caps. Outside the fuse body, each end cap is connected a conductor. The conductors extend within an insulative housing of the leadless device and terminate at a terminal portions, which extend through the housing of the device. In one embodiment the terminal portion of each conductor is aligned at least substantially flush with the outer surface of the device housing.

As illustrated below, one of the conductors extending from each fuse is connected electrically to an overvoltage protection component, e.g., a SIDACtor® overvoltage protection components. One side of the SIDACtor® components is connected to the fuse conductor, while the opposite side of the SIDACtor® components is connected to a third conductor. That third conductor in one embodiment is housed completely within the insulative housing of the device. The third conductor in one implementation extends to or bridges with the exposed surface of a second overvoltage protection component placed in series with a second fuse. The third or bridge conductor in one embodiment is placed in communication with a third overvoltage protection component or SIDACtor® components. That third SIDACtor® components in turn is connected to a conductor, which forms a return terminal that extends through the device housing in an at least substantially flush relationship with the housing. This return terminal is typically connected to earth ground in what is sometimes referred to in the art as “dual balanced longitudinal” line protection schemes.

The overvolatage protection device, e.g., SIDACtor® components, in an embodiment is a “crowbar” type, which normally has a high impedance, but which switches to a low impedance state in response to a voltage transient spike, thus clamping the voltage across it to a low level. In this first embodiment then, each signal line is protected from an overvoltage transient spike, which enables a normally non-conductive path to ground to become conductive, shunting the spike to ground and away from signal line and sensitive components connected thereto. Each signal line as discussed above is also protected by an overcurrent protection component, such as a fuse, which opens upon a sustained current overload condition due for example to the presence of a continuous abnormal voltage. One source for such abnormal voltages is a “power cross,” which occurs when an electrical power line falls across a telecom line, inducing large voltages onto the telecom line.

The two fuses and three overvoltage protection components just discussed form one assembly. In an embodiment, a second like assembly is also housed within the insulative device housing. The second assembly is configured as a mirror image of the first assembly, creating a device with four signal conductors and corresponding terminal portions extending across one dimension of the device and two ground terminals extending from the overvoltage protection components outwardly in a direction perpendicular to the signal lines. The terminal spacing of the integrated device provides a pad layout that is tailored to its particular application, such as a two-line telecom application, which includes two twisted pair lines.

The above-described integrated fuse and SIDACtor® component device is manufactured in one embodiment using a leadframe that spaces apart the fuse and SIDACtor® conductors (and corresponding fuses and SIDACtor® components) properly, enabling the conductors and components to be held together temporarily while being encapsulated within the housing. The housing thereafter holds the conductors and components in place, so that frame members of the leadframe (which extend outside the housing) can be removed, creating electrical separation between the different signal and ground conductors of the fuse and SIDACtor® component assemblies.

The leadframe in one embodiment is machined or etched from a thin blank of metal to have raised pads that center and hold the overcurrent component (e.g., cylindrical fuse) in place before and while the component is soldered to the pads and leadframe. The leadframe is also machined or etched to have pads that solder to the overvoltage component (e.g., SIDACtor® component). The leadframe can be further machined or etched to have depressions that enable the housing to be molded around a portion of the leadframe, while leaving other portions of the leadframe exposed to form terminals, which can be at least substantially flush with the housing. Machining or etching the leadframe from a blank eliminates the need to bend or form the leadframe, which can be quite small and thin. It also enables an array of leadframes to be mass-produced and separated.

In an embodiment, the device housing is injection molded or insert molded using plastic or other suitable insulating material, which can completely fill the spacing between the conductors and components and the outer surfaces of the housing. Or, the plastic or insulative housing can be molded in a hollow shape configured to hold the conductors and components fixedly in place.

In another embodiment, a similar device is provided, which again includes, for example, fuses and SIDACtor® components as overcurrent and overvoltage protection components, respectively. Here, however, the device is tailored towards a four-line telecom application. Accordingly, instead of bridging two SIDACtor® component together and joining them with a third SIDACtor® component as above, each SIDACtor® component is coupled separately to a return terminal, which is normally connected to the other line of a twisted pair, which is sometimes referred to in the art as a “ring” line. The other signal line of the twisted pair is referred to in the art as a “tip” line, is in turn fused or otherwise provided with overcurrent protection. The SIDACtor® component is thus connected across the twisted pair and clamps overvoltage transients to a low level.

In this alternative embodiment, the device can also be made as described above using a leadframe to hold the conductors and components in a temporary fixed relationship with respect to each other. The housing is then molded over the conductors and components, leaving terminal portions of the conductors exposed in a desired pattern. Afterwards, external members of the frame are removed creating electrical isolation as needed between the conductors and components.

The circuit protection of the present device can be tailored to suit a large number of electrical applications needing a variety of different types and ratings of circuit protection. For example, discussed in detail below is a device providing only overcurrent protection for each of multiple signal lines, for example four lines. The fuses are each connected to a pair of conductors, each of which terminates at a terminal portion extending through and aligning at least substantially flushly with an outer surface of the device housing.

The fuses and terminals are held separately within the housing by the housing material. Again, the fuses and conductors can be spatially fixed originally and temporarily via a leadframe, which spaces the fuses conductors apart as needed. Housing material is insert molded or injection molded to encase or enclosure the fuses and conductors, except for terminal portions located at the ends of the conductors. Afterward, exposed frame members of the leadframe are removed to electrically separate and isolate the fuses and conductors for the different signal lines.

It is therefore an advantage of the examples disclosed herein to provide a circuit protection device that conserves board space.

It is another advantage of the examples disclosed herein to provide properly coordinated integrated overvoltage and overcurrent protection.

It is a further advantage of the examples disclosed herein to provide a method of readily producing a device tailored for varying applications, mounting configurations and ratings.

It is yet another advantage of the examples disclosed herein to provide a device having at least one good performance characteristic, such as, low resistance, low conductance, low capacitance, and good heat dissipation capabilities.

Additional features and advantages are described herein, and will be apparent from, the following Detailed Description and the figures.

### BRIEF DESCRIPTION OF THE FIGURES

FIG. 1 is a top plan view of one embodiment of a leadless circuit protection device having overcurrent and overvoltage protection.

FIG. 2 is a side elevation view of the circuit protection device of FIG. 1.

FIG. 3 is a bottom plan view of the circuit protection device of FIG. 1.

FIG. 4 is a perspective view of the overcurrent and overvoltage protection components and associated conductors enclosed at least partially within the housing of the device of FIG. 1.

FIG. 5A is a plan view of a leadframe having the overvoltage and overcurrent protection components of the device of FIG. 1, which illustrates a step in producing the device.

FIG. 5B shows a second manufacturing step in which an insulative housing is applied to the leadframe before the leadframe is trimmed to produce the circuit protection device of FIG. 1.

FIG. 6A is an electrical schematic for the circuit protection device shown in FIG. 1.

FIG. 6B is an electrical circuit illustrating an application for the device of FIGS. 1 to 8.

FIG. 7 is a pin out diagram corresponding to the electrical diagram of FIG. 6.

FIG. 8 is a recommended pad layout for the circuit protection device shown in FIG. 1.

FIG. 9 is a top plan view of another embodiment of a leadless circuit protection device having overcurrent and overvoltage protection.

FIG. 10 is a side elevation view of the circuit protection device of FIG. 9

FIG. 11 is a bottom plan view of the circuit protection device of FIG. 9.

FIG. 12 is a perspective view of the overcurrent and overvoltage protection components and associated conductors enclosed at least partially within the housing of the device of FIG. 9.

FIG. 13A is a plan view of a leadframe having the overvoltage and overcurrent protection components of the device of FIG. 9, which illustrates a step in producing the device.

FIG. 13B shows a second manufacturing step in which an insulative housing is applied to the leadframe before the leadframe is trimmed to produce the circuit protection device of FIG. 9.

FIG. 14A is an electrical schematic for the circuit protection device shown in FIG. 9.

FIGS. 14B and 14C are electrical circuits illustrating various applications for the device of FIGS. 9 to 16.

FIG. 15 is a pin out diagram corresponding to the electrical diagram of FIG. 14.

FIG. 16 is a recommended pad layout for the circuit protection device shown in FIG. 9.

FIGS. 17A and 17B are perspective views illustrating one example of a leadframe suitable for mounting the overvoltage and overcurrent protection components of the leadless circuit protection devices discussed herein.

FIG. 17C is a plan view of an array of leadframes that are mass-produced and separated.

FIG. 18 is a top plan view of a third embodiment of a leadless circuit protection device providing overcurrent protection for multiple signal lines.

FIG. 19 is a side elevation view of the circuit protection device of FIG. 18

FIG. 20 is a bottom plan view of the circuit protection device of FIG. 18.

FIG. 21 is a perspective view of the overcurrent protection components and associated conductors enclosed at least partially within the housing of the device of FIG. 18.

FIG. 22A is a plan view of a leadframe having the overcurrent protection components of the device of FIG. 18, which illustrates a step in producing the device.

FIG. 22B shows a second manufacturing step in which an insulative housing is applied to the leadframe before the leadframe is trimmed to produce the circuit protection device of FIG. 18.

FIG. 23 is a recommended pad layout for the circuit protection device shown in FIG. 18.

### DETAILED DESCRIPTION

Described in detail herein are examples of leadless circuit protection devices that comply with the objectives of today's semiconductor industry, namely, to use devices that are smaller and capable of being produced at fast production rates. The embodiments disclosed herein are intended to comply with semiconductor industry standards, such as those set forth by JEDEC Publication 95, Design Guide 4.19, Quad No-Lead Staggered and In-Line Multi-Row Packages (“QFN”).

The devices in an embodiment are leadframe based, plastic encapsulated packages having low resistance, conductance, capacitance (“RLC”). The leadframe construction enables the type, nature and configuration of circuit protection components housed within the devices to be tailored to a particular application. The devices have good heat dissipation capability. Integration of overcurrent and overvoltage functions helps assure proper coordination, and the close proximity of the circuit protection components housed within the overall device enhances electrical performance. Their leadless nature also enhances electrical performance and their exposed pads improve thermal characteristics. The leadless and integrated nature of the devices reduces the printed circuit board footprint area needed for mounting. The relatively small size and low profile of the devices make the devices quite suitable for high-density printed circuit boards (“PCB's”).

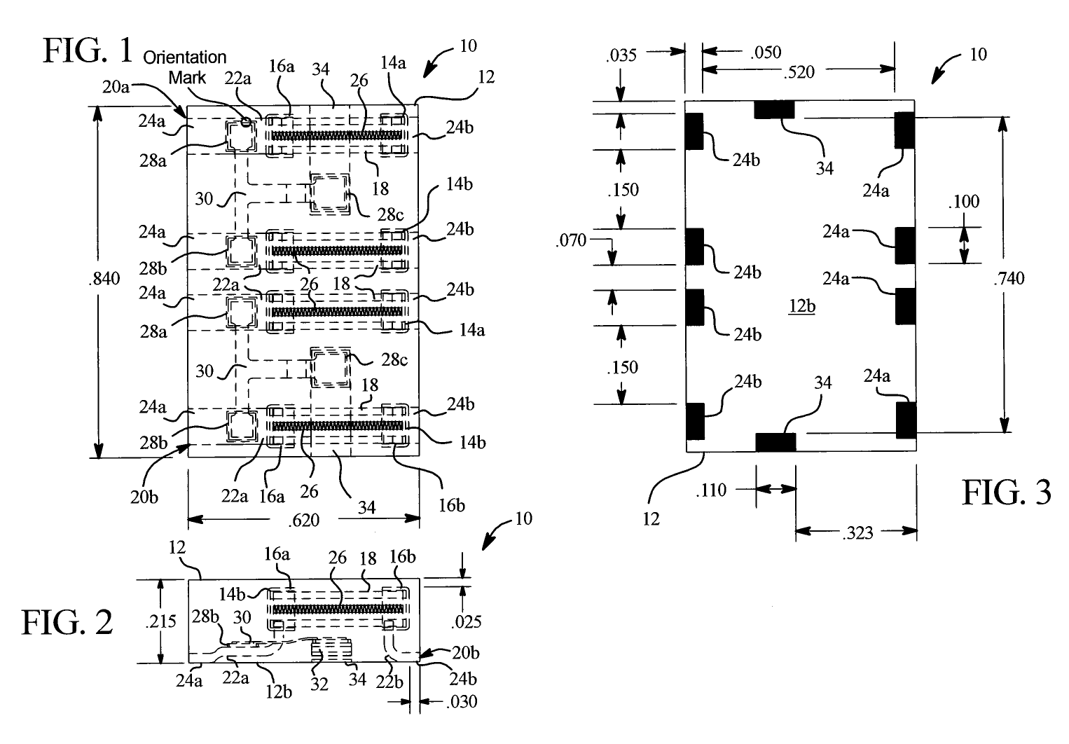

Referring now to the drawings and in particular to FIGS. 1 to 4, one embodiment of a leadless circuit protection device is illustrated by device 10. It should be appreciated that the dimensions shown in connection with FIGS. 1 to 3 are for purposes of example only and in no way are intended to limit the scope and spirit of the claims appended hereto. The dimensions as shown are in inches and highlight the compact nature of device 10, which houses overcurrent and overvoltage protection components capable of protecting telecom circuitry provided on a PCB, for example.

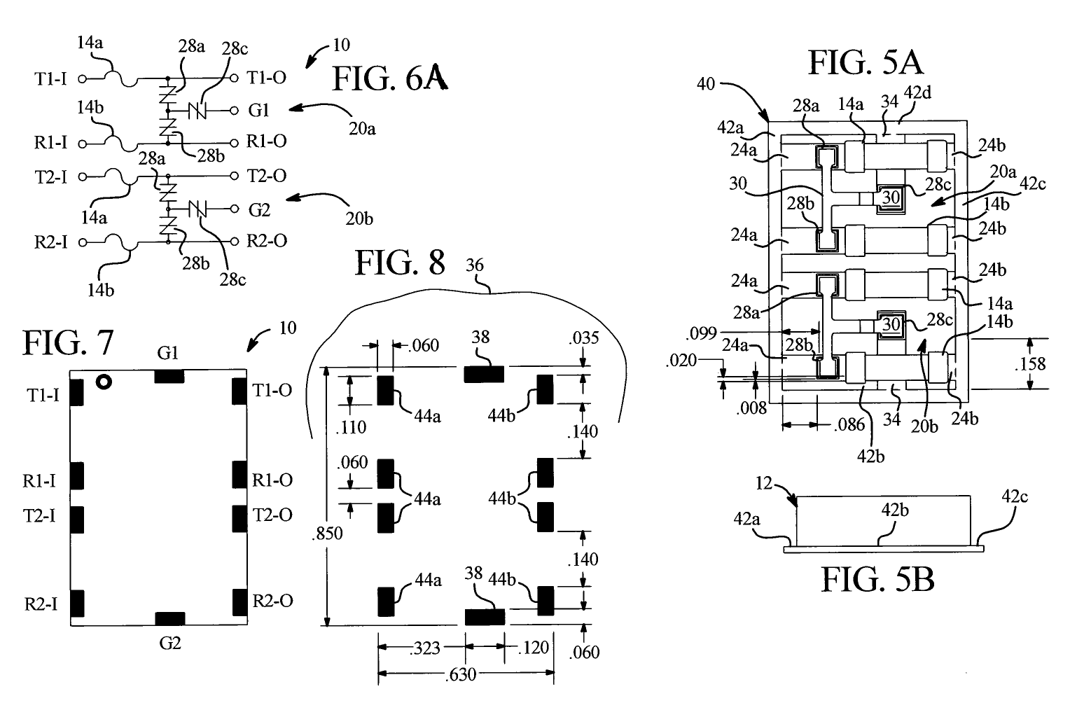

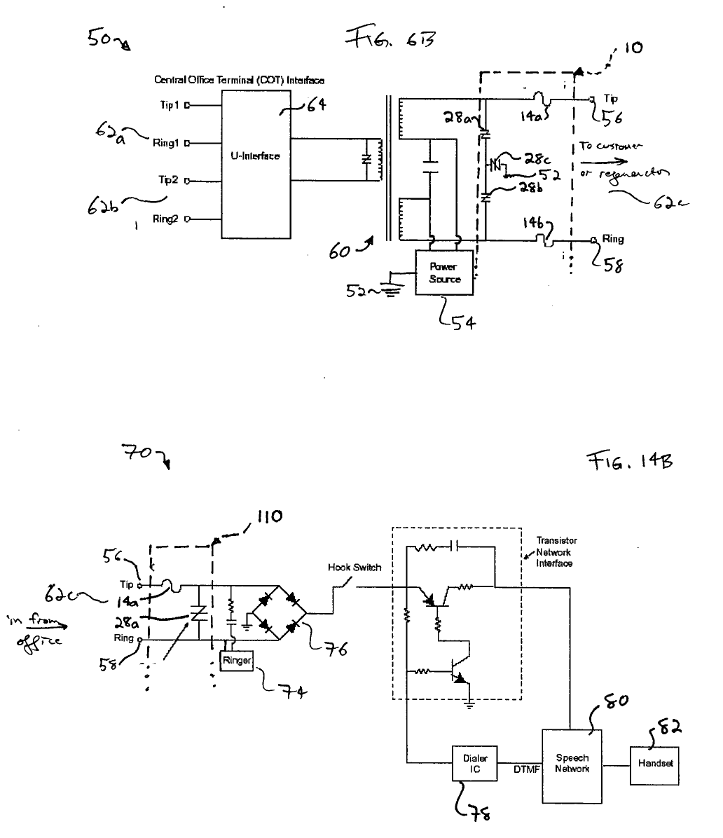

As seen in FIGS. 1 to 3, device 10 includes a protective and insulative housing 12. Insulative housing 12 shown also in connection with FIGS. 5A and 5B is molded about the overcurrent and overvoltage protection components, so as to electrically insulate the components. The housing is also configured so that terminal portions of conductors extending from the overcurrent and overvoltage protection components extend through the housing and reside at least substantially flush with an outer surface (e.g., bottom surface 12b seen in FIG. 3) of housing 12. Those terminal portions are configured to be soldered to a corresponding pad layout of the PCB (e.g., FIG. 8) via a reflow soldering process for example.

Housing 12 in an embodiment encases the overvoltage and overcurrent protection components such that housing 12 holds the devices in place without the need for housing 12 or the enclosed conductors to have specially molded or machined snaps or press-fitting apparatuses. That is, device 10 may be solid or substantially solid, in which the material of housing 12 fills the voids between the outer surfaces of housing 12 and the enclosed overcurrent and overvoltage apparatuses and associated conductors. Alternatively, housing 12 may define one or more air-gap between the outer surfaces of housing 12 and the overvoltage and overcurrent protection components. In any case, housing 12 is configured to mechanically engage enough of the components and conductors to hold the components firmly in place.

Housing 12 may be made of any suitable material. In an embodiment, housing 12 is made of any acceptable injection moldable or insert moldable material, such as polycarbonate, phenolic or epoxy. Alternatively, housing 12 may be made of a ceramic or glass-based material. Housing 12 in one preferred embodiment is rigid or semi-rigid. Housing 12 in an alternative embodiment includes an insulative protective coating or encapsulating material, such as a resin coating. The material for housing 12 in any case should be capable of withstanding the rigors of assembly, e.g., stress and heat due to pick-and-place and soldering operations

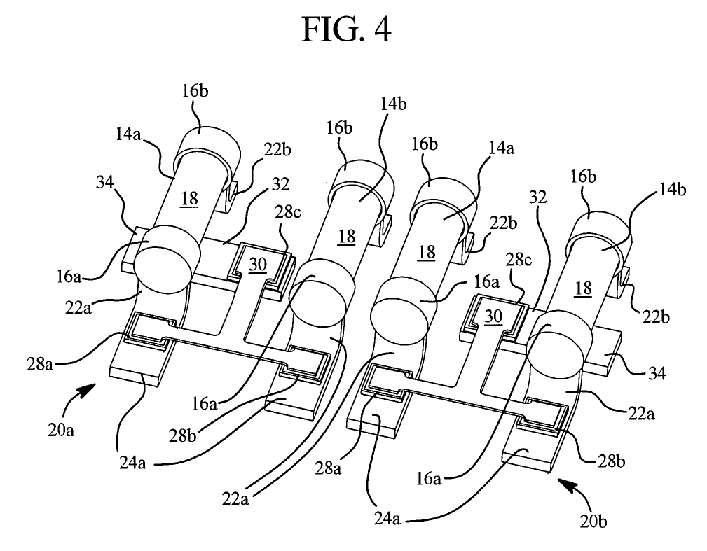

As seen in FIGS. 1 and 2, device 10 includes a first assembly 20a and a second assembly 20b. First and second assemblies 20a and 20b are shown alone in the perspective view in FIG. 4. As illustrated, assemblies 20a and 20b are mirror images of one another, which enables efficient use of available terminal location space along the bottom 12b of housing 12 to be made as seen in connection with FIG. 3. Alternatively, only a single assembly is provided or more than two assemblies are provided.

Assemblies 20a and 20b each include a first overcurrent protection component 14a and a second overcurrent protection component 14b. In the illustrated embodiment, the overcurrent protection components are fuses. One suitable fuse for overcurrent protection components 14a and 14b is a Pico® fuse manufactured by the assignee of the present invention. Although a fuse is one suitable overcurrent protection component for circuit protection device 10, other suitable overcurrent protection components for circuit protection device 10 include a ceramic or polymeric posititve temperature coefficient thermistor, a thermal limiter, or a semiconductor device.

Each fuse 14a and 14b includes first and second end caps 16a and 16b. End caps 16a and 16b may be made of any suitable one or more conductive material, such as copper, nickel, gold, silver, lead, tin, alloys thereof and layers. End caps 16a and 16b are fastened to and enclose both ends of an insulative fuse body 18. Fuse body 18 is made of any suitable electrically insulative material, such as plastic, ceramic, glass or cardboard. The material for body 18 is in one embodiment rigid and strong enough to withstand the pressure, heat and/or force applied by the molding of housing 12 about body 18. Alternatively, body 18 can be made of a relatively thin or collapsible material, but wherein body 18 is filled with a supportive insulative material, such as sand.

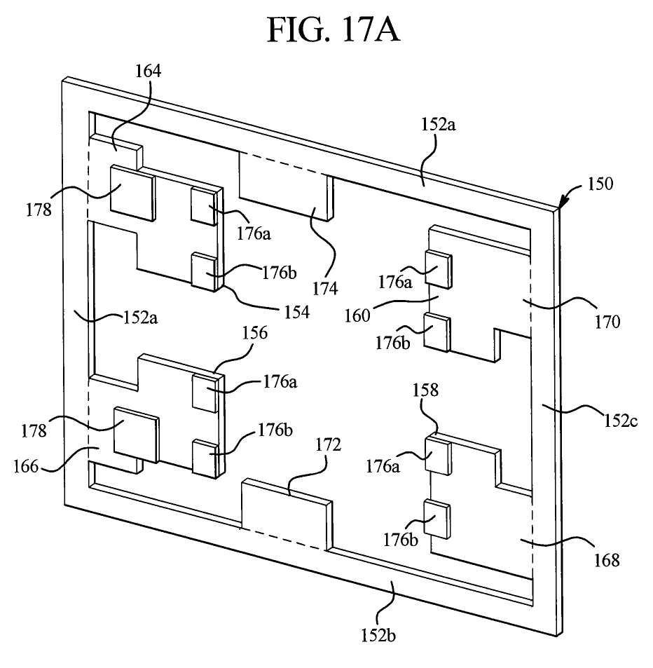

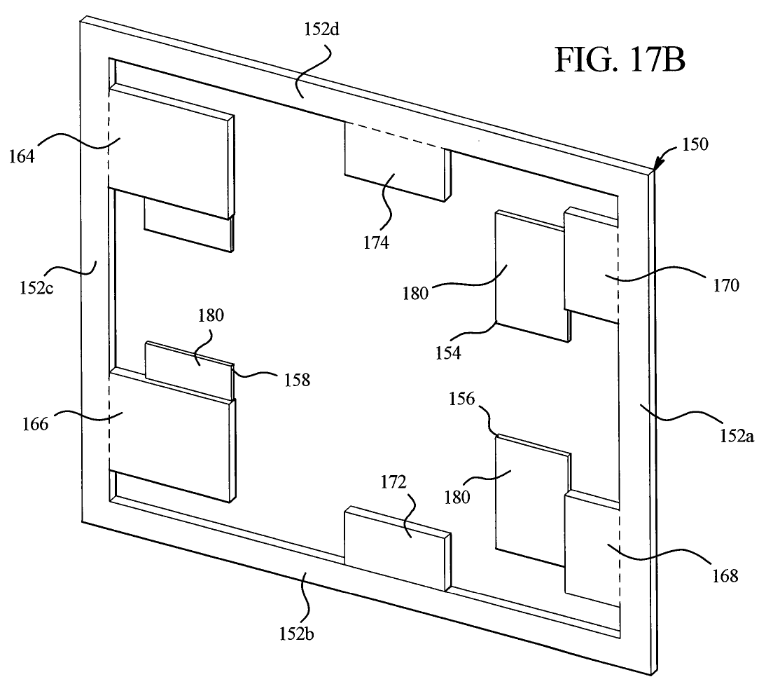

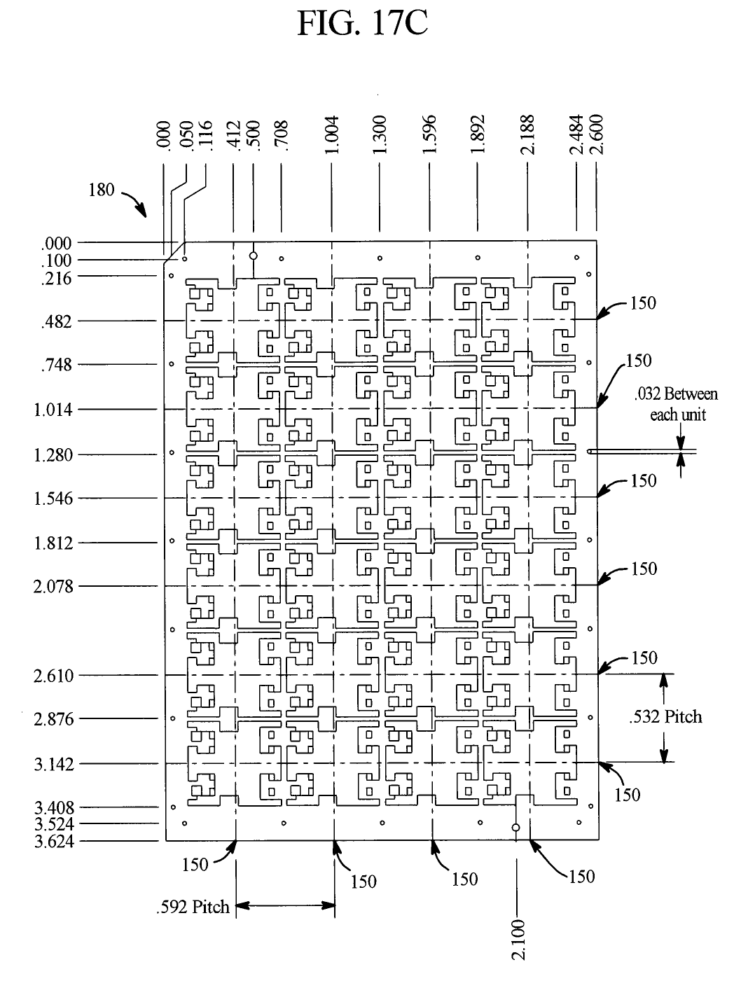

As seen best in FIG. 2, end caps 16a and 16b are connected electrically and physically in an embodiment to conductors 22a and 22b, respectively. Conductors 22a and 22b are made of any suitable conductive material, such as copper, nickel, gold, silver, lead, tin, alloys thereof and layers thereof. Conductors 22a and 22b in an embodiment are press-fitted onto, integral with and/or soldered respectively to end caps 16a and 16b. Alternatively, conductors 22a and 22b are machined or etched according to the teachings of leadframe 150 of FIGS. 17A to 17C.

As seen best in FIG. 2, a portion of conductors 22a and 22b is enclosed within housing 12. Whether or not housing 12 is solid throughout device 10 (except for the components and conductors), housing 12 in one preferred embodiment is molded around conductors 22a and 22b for each of fuses 14a and 14b of assemblies 20a and 20b. Housing 12 is thereby fixed around conductors 22a and 22b so that housing 12 holds the corresponding assemblies 20a and 20b in place firmly.

As seen in FIG. 2, terminal portions 24a and 24b extend from each of conductors 22a and 22b, respectively. Terminal portions 24a and 24b extend through housing 12 and in an embodiment reside at least substantially flush with a bottom surface 12b of housing 12. Terminal portions 24a and 24b can extend slightly below bottom surface 12b of housing 12 to ensure proper electrical contact with the pads shown in the pad layout of FIG. 8. It should be appreciated, however, that the solder paste applied to the pads of PCB 36 of FIG. 8 should provide a suitable positive electrical engagement between the pads of FIG. 8 and the terminal portions 24a and 24b even if terminal portions 24a and 24b are exactly flush with bottom surface 12b of housing 12. The contour of device 10 can therefore be at least substantially smooth, as shown in connection with FIGS. 1 to 3.

Fuses 14a and 14b each include a fuse element 26, which is connected electrically to (and in an embodiment fastened to) end caps 16a and 16b. Fuse element 26 enables normal operating currents and the currents associated by transient events, such as lightning, to be transferred through the signal lines protected by device 10. When subjected to a continuous abnormal current, such as that caused by a power cross condition, element 26 opens, which opens a protected signal line connected to the respective terminals 24a and 24b. Elements 26 of overcurrent protection components 14a and 14b of assemblies 20a and 20b may have any suitable rating, such as about½ to about two amperes. The ratings for elements 26 of the different fuses 14a and 14b may each be the same, different or any combination thereof.

In the illustrated embodiment, overcurrent protection components 14a and 14b are not resettable. That is, once an element 26 of a fuse 14a or 14b opens, the element is opened permanently. One especially useful application for device 10 is accordingly one in which the PCB to which device 10 is connected will have to be reworked or replaced after an element opening condition occurs. Such applications include telecommunication network line cards and subscriber premises equipment such as modems and phones.

In an alternative embodiment, overcurrent protection components 14a and 14b are resettable. Examples of suitable resettable overcurrent protection components 14a and 14b include ceramic or polymeric posititve temperature coefficient thermistors, thermal limiters, or semiconductor devices.

Device 10 provides overcurrent and overvoltage protection to the circuitry to which device 10 is connected. In the illustrated embodiment, overvoltage protection is provided for each protected signal line by an overvoltage protection component, e.g., a two-terminal protection thyristor, such as a SIDACtor® component. In particular, assembly 20a includes a first SIDACtor® component 28a, which is placed in electrical communication with conductor 22a, which in turn is coupled electrically to fuse 14a. Assembly 20a also includes a second overvoltage protection component or SIDACtor® component 28b coupled electrically to conductor 22a, which in turn is connected electrically to fuse 14b. Assembly 20b, located within housing 12 of device 10, also includes first and second overvoltage protection components 28a and 28b connected in the like locations as with assembly 20a. Overvoltage protection components 28a and 28b are connected electrically to conductors 22a via any suitable process, such as a soldering process, conductive adhesive, etc.

Overvoltage protection components 28a and 28b in one embodiment are SIDACtor® components provided by Littelfuseg®, Inc., the assignee of this application. SIDACtor® components 28a and 28b are two terminal thyristors with bi-directional current carrying capability, which act as solid-state semidconductor switches. SIDACtor® s components 28a and 28b can be a four-layer semiconducting device, with each layer consisting of an alternately N or P-type material, for example N-P-N-P. The main terminals (anode and cathode terminals) extend across the full four layers.

SIDACtor® components 28a and 28b are “crowbar” type devices that normally present a high impedance path between conductors 22a and ground. Upon experiencing a transient voltage spike, the SIDACtor® components switch to a low impedance state, clamping the voltage to a low value and allowing current to flow to ground. The components remain conducting as long as the transient lasts. After the transient is dissipated, the overvoltage protection component switches off and reestablishes a high impedance path to ground. SIDACtor® components 28a and 28b are therefore resettable. In one embodiment SIDACtor® components 28a and 28b are rated to switch from the high impedance state to low impedance at two hundred twenty-five volts or greater. Other suitable “crowbar” type overvoltage protection components for device 10 include polymer based voltage variable material (“VVM”) components and gas-filled discharge tube (“GDT”) components. In the illustrated embodiment, overvoltage protection components 28a and 28b of assemblies 20a and 20b are each connected to an internal conductor 30. Here, internal conductor 30 is completely enclosed within housing 12 and forms a bridge between SIDACtor® components 28a and 28b of the respective assembly 20a or 20b. The leg of the T-shaped conductor 30 extends to a third SIDACtor® component 28c. Third SIDACtor® component 28c is mounted or connected electrically to a ground conductor 32 (see FIG. 4). Third SIDACtor® component 28c is provided for each assembly 20a and 20b.

Ground conductors 32 are partially covered by housing 12. Like conductors 22a and 22b, ground conductors 32 extend to and include ground terminals 34. Ground terminals 34 can be the common line for earth ground or shield ground. Ground terminals 34, like terminals 24a and 24b, extend through housing 12 and in an embodiment reside at least substantially flush with a bottom surface 12b of housing 12. Terminal portions 34 can extend slightly below bottom surface 12b of housing 12 to ensure proper electrical contact with the pads shown in the pad layout of FIG. 8. The solder paste applied to the pads of PCB 36 of FIG. 8 should provide a suitable positive electrical engagement between the pads of FIG. 8 and ground terminal portions 34 even if the terminals are exactly flush with bottom surface 12b of housing 12.

In one embodiment, the holding current of SIDACtor® component 28c is lower than that of SIDACtor® components 28a and 28b. Here, SIDACtor® component 28c triggers and conducts first to help SIDACtor® components 28a and 28b to trigger and conduct in unison and to hold the tip and ring lines of the two line telecom circuit in balance during switching. The resulting relative switching of SIDACtor® components 28a and 28b may take place within 0.5 microseconds for example. The holding current of SIDACtor® component 28c in one implementation is, for example, twenty milliamps. The SIDACtor® configuration of FIGS. 1 to 8 is described in U.S. Pat. No. 4,905,119 (“the '119 Patent”), the entire teachings of which are incorporated herein by reference.

Referring now to FIGS. 5A and 5B, steps in the manufacturing process of device 10 are illustrated. FIG. 5A shows that assemblies 20a and 20b are formed initially on or via a leadframe 40. For reference, overcurrent protection components 14a and 14b of assemblies 20a and 20b are illustrated. Further, overvoltage protection components 28a to 28c for assemblies 20a and 20b are illustrated. Also, terminals 24a, 24b and 34 for each assembly 20a and 20b are shown for reference.

As illustrated, leadframe 40 includes members 42a, 42b, 42c and 42d. Frame members 42a to 42d are formed integrally with terminals 24a, 24b, 34 and their associated conductors 22a, 22b and 32, respectively, of each assembly 20a and 20b. The integral structure sets the spacing for the various conductors and components of device 10. Leadframe 40 in an embodiment is laser-cut, stamped, wire electrical discharge machined (“EDM”) or otherwise formed via any suitable metal-forming process.

In one embodiment, components 28a to 28c, 14a, 14b and bridging conductor 30 are connected electrically to leadframe 40. Afterward, housing 12 is molded over the components, portions of conductors 22a, 22b and 32 and all of conductors 30. Terminals 24a, 24b and 34 extend through housing 12 as discussed above.

Frame members 42a, 42b, 42c and 42d are removed or cut away from the subassembly shown in FIG. 5B to separate the different terminal portions and components electrically, while leaving the components and terminal portions in proper relative positioning. As seen in FIG. 5A, frame member 42a is removed from terminals 24a along the dashed lines, separating the terminals. Frame member 42b is removed from terminal 34 along the dashed line, separating the terminal. Frame member 42c is removed from terminal portions 24b along the dashed lines, separating those terminals. Also, frame member 42d is separated from terminal 34 along the dashed line shown in FIG. 5A.

Referring now to FIG. 6A, an electrical schematic for subassemblies 20a and 20b is illustrated. In one example, device 10 is used to protect a two-line telecom circuit. The node designations accordingly correspond to a two-line telecom circuit. That is, the first tip inlet node T1-I of the telecom circuit is connected electrically to fuse 14a, which fusedly connects the first tip inlet T1-I to a first tip outlet T1-O. Likewise, fuse 14b fusibly connects a first ring line input R1-I and a first ring line output RI-O. Overvoltage protection devices 28a to 28c protect the first tip and ring lines by clamping the volatge across the tip and ring lines to a low value and shunting transient energy to ground G1 upon an overvoltage event as described above.

Likewise, in connection with assembly 20b fuse 14a protects the second tip line (T2-I/T2-O), while fuse 14b protects the second ring line (R2-I/R2-O). SIDACtor® components 28a to 28c protect the second tip and ring lines from a transient by switching to a low impedance state upon the overvoltage event, clamping the voltage across the tip and ring lines to a low value and shunting same to ground G2 as described above.

Referring now to FIG. 6B, one application for device 10 is illustrated by electrical circuit 50, which represents a high-speed control office terminal (“COT”) interfaces for a telephone company. Here, longitudinal protection is needed and provided because of the connection of power source 54 to ground 52. Power source 54 provides 48 VDC, for example, to COT circuit 50. SIDACOtor® devices 28a and 28b provide overvoltage protection to tip and ring lines 56 and 58, respectively, and as seen in FIG. 6B. SIDACOtor® device 28c serves the purpose discussed in the '119 Patent. Fuses 14a and 14b (which can be TeleLink® fuses provided by Littelfuseg® Inc., the assignee of the present application) provide overcurrent protection to tip and ring lines 56 and 58, respectively.

Overvoltage protection devices 28a and 28b protect COT circuit 50 for example from a lighting strike or other overvoltage event. Fuses 14a and 14b protect transformer 60 and overvoltage protection devices 28a and 28b from power induction or power-cross, e.g., a continuous high voltage induced on twisted pairs 62a, 62b or 62c, for example, if any of the twisted pairs comes into prolonged contact with power wiring. Twisted pairs 62a and 62b are simplex type pairs, wherein one pair is dedicated to transmitting data and one pair is dedicated to receiving data. The transmit data and receive data on pairs 62a and 62b are merged via U-interface 64, which can be a chip or other type of circuitry, and are sent out then in a duplex fashion along tip and ring lines 56 and 58 to the customer premise shown in connection with schematic 70 of FIG. 14B.

Because tip and ring lines 56 and 58 have a reference to ground, separate overvoltage protection devices 28c and 28d are needed, and placed in series as shown. In this manner, tip and ring lines 56 and 58 are protected independently if an overvoltage occurs on only one of the lines or simultaneously if the overvoltage occurs on both tip and ring lines 56 and 58. Combined with fuses 14a and 14b protecting the tip and ring lines, the electrical protection provided by device 10 to COT circuit 50 is termed “longitudinal” protection, which provides protection with respect to ground.

The illustrated device 10 is able to protect two sets of duplex twisted parts 62c of COT circuit 50 (only one shown), wherein each pair 62c has a tip and a ring line 56 and 58. Protection by a single device 10 of two twisted pairs 62c is shown below in connection with FIG. 14C, in which COT circuit 50 communicates with a regenerator circuit 90. Twisted pairs 62c can extend alternatively from COT circuit 50 to a customer circuit 70 shown below in connection with FIG. 14B.

FIG. 7 illustrates the pin-out diagram for device 10. The designations discussed above in connection with the electrical diagram of FIG. 6A correspond to each of the designations for the pin-out diagram.

Referring now to FIG. 8, an embodiment of a pad layout for device 10 is illustrated. The dimensions shown in connection with FIGS. 8 are for purposes of example only and in no way are intended to limit the scope and spirit of the claims appended hereto. The pad layout for pads 38, 44a and 44b is provided on PCB 36 via any suitable process, such as photo-etching. Pads 38, 44a and 44b in an embodiment are copper. Terminal portions 24a, 24b and 34 are soldered respectively to pads 44a, 44b and 38 via any suitable soldering process, such as reflow soldering.

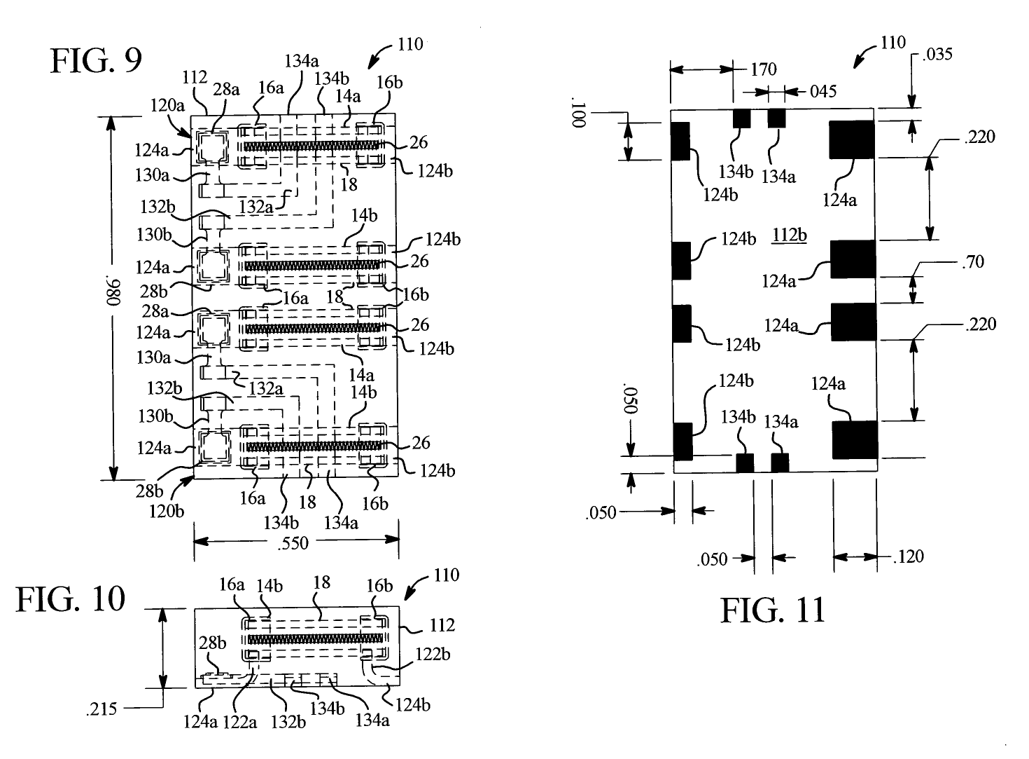

Referring now to to FIGS. 9 to 12, another embodiment of a leadless circuit protection device is illustrated by device 110. It should be appreciated that the dimensions shown in connection with FIGS. 9 to 11 are for purposes of example only and in no way are intended to limit the scope and spirit of the claims appended hereto. The dimensions in inches highlight the compact nature of device 110, which houses overcurrent and overvoltage protection components capable of protecting for example a four line telecom circuit provided on a PCB, for example.

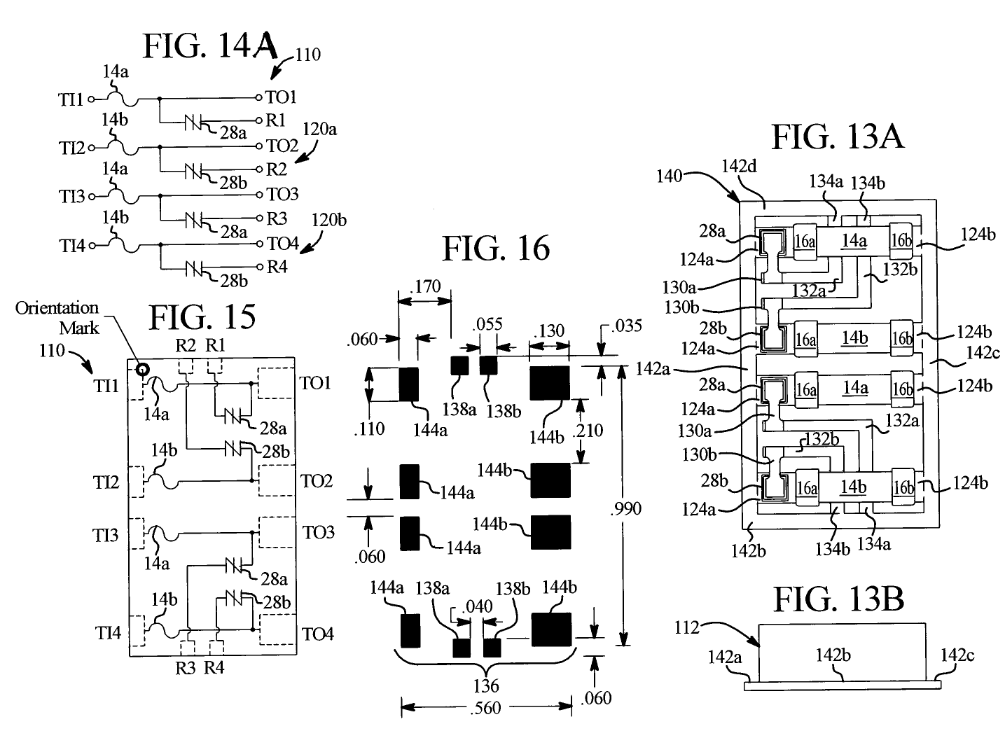

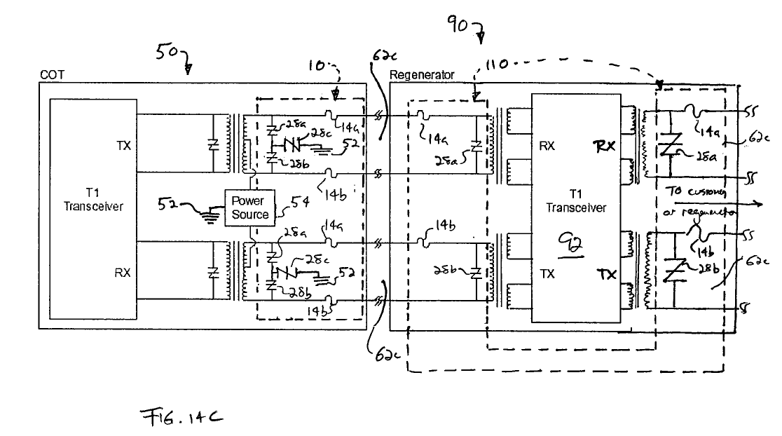

As seen in FIGS. 9 to 11, device 110 includes a protective and insulative housing 112. Insulative housing 112 shown also in connection with FIGS. 13A and 13B is molded in one embodiment about the overcurrent and overvoltage protection components. In the illustrated embodiment, terminal portions of conductors extending from the overcurrent and overvoltage protection components extend through housing 112 and reside at least substantially flush with an outer surface (e.g., bottom surface 112b seen in FIG. 11) of housing 112. Those terminal portions are configured to be soldered to a corresponding pad layout of the PCB (e.g., FIG. 16) via a reflow soldering process for example.

Housing 112 as before holds the components in place without the need for housing 112 or the conductors within the housing to have specially molded or machined snaps or press-fitting apparatuses. Device 110 may be solid or substantially solid, wherein the material of housing 112 fills the voids between the outer surfaces of housing 112 and the enclosed overcurrent and overvoltage apparatuses and associated conductors. Alternatively, housing 112 may define one or more air-gap between the outer surfaces of housing 112 and the overvoltage and overcurrent protection components. Here, housing 112 is configured to mechanically engage enough of the components and conductors to hold the components firmly in place.

Housing 112 is made of any of the materials described above for housing 12. Housing 112 in one preferred embodiment is rigid or semi-rigid. Housing 112 in an alternative embodiment includes an insulative protective coating or encapsulating material, such as a resin coating.

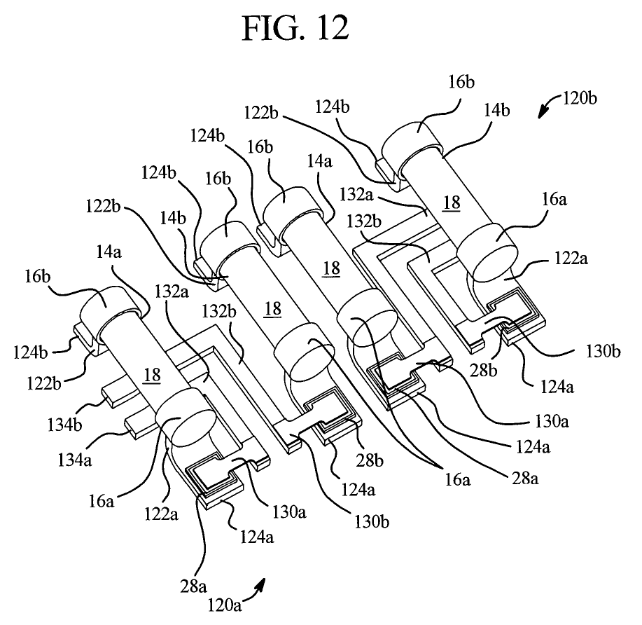

As seen in FIGS. 9 and 10, device 110 includes a first cooperating structure 120a and a second cooperating structure 120b (having conductors configured to cooperate to conserve space but not connected physically as with device 10). First and second cooperating structures 120a and 120b are shown alone in the perspective view in FIG. 12. As illustrated, cooperating structures 120a and 120b are mirror images of one another, which enables efficient use of available terminal location space along the bottom 112b of housing 112 to be made. Alternatively, only a single cooperating structure or more than two structures are provided.

Cooperating structures 120a and 120b each include a first overcurrent protection component 14a and a second overcurrent protection component 14b. In the illustrated embodiment, the overcurrent protection components are again fuses, such as a Pico® fuse manufactured by the assignee of the present invention. Any of the alternative devices listed above for overcurrent protection components 14a and 14b can be used for components 14a and 14b of device 110.

Each fuse 14a and 14b includes first and second end caps 16a and 16b, insulative body 18 and fuse element 26 as described above (including all alternative embodiments) for fuses 14a and 14b of device 10. Fuse element 26 enables normal operating currents and the currents associated with transient events, such as lightning, to be transferred through the signal lines protected by device 110. When subjected to a continuous abnormal current, such as that caused by a power-cross condition, element 26 opens, which opens a protected signal line connected to the respective terminals 124a and 124b.

Elements 26 of overcurrent protection components 14a and 14b of cooperating structures 120a and 120b may have any suitable rating, such as ½ to two amperes. The ratings for elements 26 of the different fuses of device 110 may each be the same, different or any combination thereof. In the illustrated embodiment, overcurrent protection components 14a and 14b are not resettable. That is, once an element 26 of a fuse 14a or 14b opens, the element is opened permanently. In an alternative embodiment, overcurrent protection components 14a and 14b are resettable, such as any of the resettable overcurrent devices listed above.

As seen best in FIG. 10, end caps 16a and 16b are connected electrically and physically in an embodiment to conductors 122a and 122b, respectively. Conductors 122a and 122b are made of any suitable conductive material, such as any of those listed for conductors 22a and 22b. Conductors 122a and 122b in an embodiment are press-fitted onto, integral with and/or soldered respectively to end caps 16a and 16b. Alternatively, conductors 122a and 122b are machined or etched according to the teachings of leadframe 150 of FIGS. 17A to 17C.

As seen best in FIG. 10, a portion of conductors 122a and 122b is enclosed within housing 112. Whether or not housing 112 is solid throughout device 110 (except for the components and conductors), housing 112 in one preferred embodiment is molded around conductors 122a and 122b for each of fuses 14a and 14b of structures 120a and 120b. Housing 112 is thereby fixed around conductors 122a and 122b so that housing 112 holds the corresponding structures 120a and 120b in place firmly.

As seen in FIG. 10, terminal portions 124a and 124b extend from each of conductors 122a and 122b, respectively. Terminal portions 124a and 124b extend through housing 112 and in an embodiment reside at least substantially flush with a bottom surface 112b of housing 112. The contour of device 110 can be at least substantially smooth, as shown in connection with FIGS. 9 to 11. Terminal portions 124a and 124b can alternatively extend slightly below bottom surface 112b of housing 112 as described above.

Device 110, like device 10, provides overcurrent and overvoltage protection to the circuitry to which device 110 is connected. Cooperating structure 120a includes a first two-terminal protection thyristor, such as a SIDACtor® component 28a, which is placed in electrical communication with conductor 122a, which in turn is coupled electrically to fuse 14a. Cooperating structure 120a also includes a second overvoltage protection component or SIDACtor® component 28b coupled electrically to conductor 122a, which in turn is connected electrically to fuse 14b.

Cooperating structure 120b, located within housing 112 of device 110, also includes first and second overvoltage protection components 28a and 28b connected in the same locations as with cooperating structure 120a. Overvoltage protection components 28a and 28b are connected electrically to conductors 122a via any suitable process, such as a soldering process, conductive adhesive, etc.

[As described above, upon experiencing a transient voltage spike, the SIDACtor® components 28a and 28b switch to a low impedance state enabling the transient to be shunted to ground and remain conducting as long as the transient lasts. After the transient is dissipated, the overvoltage protection component switches off and reestablishes a high impedance path to ground. SIDACtor® components 28a and 28b are therefore resettable and can be rated to switch from a high impedance state to a low impedance state at about two-hundred twenty-five volts or greater. Other suitable “crowbar” type overvoltage protection components for device 110 include any of the components listed above for device 10.]

In the illustrated embodiment, overvoltage protection components 28a and 28b of cooperating structures 120a and 120b are connected to separate internal conductors 130a and 130b, respectively. Internal conductors 130a and 130b are completely enclosed within housing 112, but unlike conductors 30 of device 10, conductors 130a and 130b do not form a bridge between SIDACtor® components 28a and 28b of the respective cooperating structures 120a or 120b. Device 110 does not provide a third SIDACtor® component 28c, which is provided in device 10 [why needed before but not now? Does it have something to do with 4 line versus 2 line application?].

Internal conductors 130a and 130b of cooperating structures 120a and 120b are connected respectively to ground conductors 132a and 132b, which are each partially covered by housing 112. Ground conductors 132a and 132b as shown are angled, shaped and/or formed so as to extend between conductors 122a and 122b of outer fuses 14a and 14b of cooperating structures 120a and 120b, respectively. Grounding thereby occurs along the short sides of device 110.

Like conductors 122a and 122b, ground conductors 132a and 132b extend to and include respective ground terminals 134a and 134b, respectively. Ground terminals 134a and 134b can be common lines for earth ground or shield ground. Ground terminals 134a and 134b, like terminals 124a and 124b, extend through housing 112 and in an embodiment reside at least substantially flush with a bottom surface 112b of housing 112. Alternativerly, terminal portions 134a and 134b can extend slightly below bottom surface 112b of housing 112 to ensure proper electrical contact with the pads shown in the pad layout of FIG. 16. Further alternatively, conductors 130a/130b and 132a/132b (and thus terminals 134a/134b) can be formed from a single piece of metal.

Referring now to FIGS. 13A and 13B, steps in the manufacturing process of device 110 are illustrated. FIG. 13A shows that cooperating structures 120a and 120b are formed initially on or via a leadframe 140. For reference, overcurrent protection components 14a and 14b of structures 120a and 120b are illustrated. Further, overvoltage protection components 28a and 28b of structures 120a and 120b are illustrated. Also, terminals 124a, 124b, 134a and 134b for each cooperating structure 120a and 120b are shown for reference.

As illustrated, leadframe 140 includes frame members 142a, 142b, 142c and 142d. Frame members 142a to 142d are formed integrally with terminals 124a, 124b, 134 and their associated conductors 122a, 122b and 132, respectively, of each cooperating structure 120a and 120b. The integral structure sets the spacing for the various conductors and components of device 110. Leadframe 140 in an embodiment is laser-cut, stamped, wire electrical discharge machined (“EDM”) or otherwise formed via any suitable metal-forming process.

In one embodiment, components 28a, 28b, 14a, 14b and internal conductors 130a and 130b are connected electrically to leadframe 140. Afterward, housing 112 is molded over the components, portions of conductors 122a, 122b, 132a and 132b and all of conductors 130a and 130b. Terminals 124a, 124b, 134a and 134b extend through housing 12 as discussed above.

Frame members 142a, 142b, 142c and 142d are removed or cut away from the subassembly shown in FIG. 13B to separate the different terminal portions and components electrically, while leaving the components and terminal portions in proper relative positioning. As seen in FIG. 13A, frame member 142a is removed from terminals 124a along the dashed lines, separating the terminals. Frame member 142b is removed from terminals 134a and 134b along the dashed line, separating the terminals. Frame member 142c is removed from terminal portions 124b along the dashed lines, separating those terminals. Also, frame member 142d is separated from terminals 134a and 134b along the dashed line shown in FIG. 13A.

Referring now to FIG. 14A, an electrical schematic for cooperating structures 120a and 120b of device 110 is illustrated. In one example, device 110 is used to protect a four-line telecom circuit. The node designations accordingly correspond to a four-line telecom circuit. That is, for the first cooperating structure 120a the first tip inlet node T11 of the telecom circuit is connected electrically to fuse 14a, which fusedly connects the first tip inlet T11 to a first tip outlet TO1. Likewise, fuse 14b fusibly connects a second tip inlet T12 to a second tip outlet TO2. Overvoltage protection devices 28a and 28b protect the first and second tip lines by shunting transient energy to separate ground nodes R1 and R2, respectively, upon an overvoltage event.

Likewise, in connection with cooperating structure 120b fuse 14a protects a third tip line (T13/TO3), while fuse 14b protects a fourth tip line (T14/TO4). SIDACtor® components 28a and 28b of cooperating structure 120b protect the third and fourth tip lines from a transient by switching to a low impedance state upon the overvoltage event and shunting same to separate ground nodes R3 and R4.

Referring now to FIG. 14B, one application for device 110 is illustrated by electrical circuit 70, which represents the electrical circuit of a user's telephone headset inside a customer premises or home. Here, a single full-duplex twisted pair 62c (coming for example from tip and ring lines 56 and 58 of circuit 50 of FIG. 6B) is provided with no reference to ground. The ringer 74, bridge rectifier 76, dialer 75, speech network 80 and handset 82, etc., are each powered by the 48 VDC of COT circuit 50 and are electrically “floating” with respect to ground. As such, overvoltage components 28a and 28b activate when a voltage mismatch occurs between the tip line of twisted pair 62c and the ring line of twisted pair 62c. For example, if a high voltage occurs on the tip line, producing a higher voltage than that seen by the ring line of pair 62c, overvoltage component 28a is activated, collapsing the voltage across the tip and ring lines. Likewise, if a high voltage occurs on the ring line, producing a higher voltage than that seen by the tip line of pair 62c, overvoltage component 28a is again activated, collapsing the voltage across the tip and ring lines. If the overvoltage occurs on both tip and ring lines of pair 62c, component 28a is not activated because the voltage is common to both lines and is canceled upon reaching bridge rectifier 76.

Fuse 14a protects against a power-cross occurring along the twisted pair 62c. With twisted pari 62c, nothing is referenced to ground and the circuit is said to be floating. Any overvoltage occurs between the two lines. Accordingly, only one of the two lines, tip line 56 or ring line 58, needs to be fused. Opening one line will mitigate the damage from the overvoltage occurring across tip line 56 and ring line 58. Device 110 including four sets of overcurrent and overvoltage components can protect four customer circuits 70.

Referring now to FIG. 14C, COT circuit 50 operating with device 10 (shown above in FIG. 6B) is shown operably connected to a telephone regenerator circuit 90, operating with protection device 110. The two outgoing twisted pairs 26c from COT circuit 50 consume an entire device 10, providing four pairs of overcurrent and overvoltage components in one embodiment. Device 10 protects each line of pairs 62c with respect to ground 52 as described above. The signals out of COT circuit 50, powered by, e.g., 48 VDC of from source 54, can travel along full-duplex twisted pair 62c for approximately 2000 yards (indicated by the double section lines) before needing regeneration. Circuit 90 performs such regeneration.

Circuit 90 can be an integrated circuit on a printed circuit board (“PCB”) for example. The PCB may contain many such integrated circuits, each having one or more regenerator circuit 90. in the illustrated embodiment, regenerator circuit 90 consumes one protection device 110. Incoming duplex twisted pairs 62c, transceiver 92 and outgoing duplex twisted pairs 62c are each powered by COT circuit 50, such that the tip and ring lines of each of the incoming and outgoing pairs 62c are “floating” with respect to ground as with customer circuit 70 of FIG. 14B. Accordingly, a high voltage occurring on both tip and ring lines of any of the twisted pairs 62c does not activate the associated overvoltage protection component 14a or 14b. A high voltage occurring on only one of tip or ring line of any of the twisted pairs 62c does activate the associated overvoltage protection component 14a or 14b, collapsing the voltage across the tip and ring lines.

FIG. 15 illustrates the pin-out diagram for device 110. The node designations discussed above in connection with the electrical diagram of FIG. 14 correspond to each of the designations for the pin-out diagram. Fuses 14a and 14b and SIDACtor® components 28a and 28b are shown figuratively connected to those node designations.

Referring now to FIG. 16, an embodiment of a pad layout for device 110 is illustrated. The dimensions shown in connection with FIG. 16 are for purposes of example only and in no way are intended to limit the scope and spirit of the claims appended hereto. The pad layout for pads 138a, 138b, 144a and 144b is provided on PCB 136 via any suitable process, such as photoetching. Pads 138a, 138b, 144a and 144b in an embodiment are copper. Terminal portions 124a, 124b, 134a and 134b of device 110 are soldered respectively to pads 144a, 144b, 138a and 138b via any suitable soldering process, such as reflow soldering.

Referring now to FIGS. 17A and 17B, front and rear views respectively of a leadframe 150 are illustrated. The teachings associated with leadframe 150 are applicable to the leadframes of devices 10, 110 and 210 discussed herein. That is, any one or more of corresponding leadframes 40, 140 and 240 may be made alternatively according to the following teachings.

Leadframe 150 includes borders 152a, 152b, 152c and 152d. Leadframe 150 also includes signal conductors 154, 156, 158 and 160. Signal conductors 154, 156, 158 and 160 extend respectively to terminals portions 162, 164, 168 and 170. Leadframe 150 further includes ground terminals 172 and 174.

Borders 152a, 152b, 152c and 152d are eventually broken away from (i) terminal portions 164 and 166 of signal conductors 154, 156; (ii) ground terminal 172; (iii) terminal portions 168 and 170 of signal conductors 158 and 160; and (iv) ground terminal 174, respectively, as described above in connection with FIGS. 5A/5B and 13A/13B, along the dashed lines to separate the different terminal portions and components electrically, while leaving the components and terminal portions in proper relative positioning.

In one embodiment, leadframe 150 is machined or etched from a single piece of metal, such as copper. As seen in FIG. 17A, the fronts or topsides of signal conductors 154, 156, 158 and 160 each include or define pads 176a and 176b. Pads 176a and 176b hold end caps 16a and 16b of fuses 14a and 14b rotationally stable and provide a metal to metal contact with end caps 16a and 16b that is conducive to the soldering of fuses 14a and 14b to conductors 154, 156, 158 and 160. The raised pads 176a and 176b are also easier to form than the bent conductors 22a/22b and 122a/122b discussed above, which also contact end caps 16a and 16b.

Signal conductors 154 and 156 also each include or define a pad 178. Pads 178 are sized and configured to receive and be soldered to a SIDACtor® or SIDACtor® SIDACtor® components 28a or 28b. Pads 178 are also machined or etched from the original blank of metal. The height of the pads 176a, 176b and 178 (or depth of the machining or etching) in one implementation is about 0.005 inch. The overall blank thickness for lead frame can be about 0.025 inch, leaving a border and terminal thickness of about 0.02 inch in one embodiment.

FIG. 17B illustrates that conductors 154, 156, 158 and 160 each further include or define depressed portions 180. Depressed portions 180 enable the plastic or otherwise insulative material of the housing to extend beneath the portions 180 to secure conductors 154 to 160 and the components mounted to the conductors. The non-depressed portions of conductors 154 to 160 form terminal portions 164 to 170, respectively, with the bottom of the housing being at least substantially flush with terminal portions 164 to 170 in one embodiment. Depressed portions 180 may be machined or etched a depth of about 0.01 inch for example.

Leadframe 150 is advantage in one respect because it requires no bending or forming, which may be difficult given its length and width (e.g., about 0.50 ×0.56 inch) and thickness (e.g., about 0.025 inch). Further, as seen in FIG. 17C, the machining or etching process may be performed on a large mass-produced scale via an array 180 of many leadframes 150. After being mass-machined or etched, individual leadframes 150 may be separated from array 180 and assembled in a device. The dimensions shown in FIG. 17C are for illustration purposes only and in no way are intended to limit the scope of the claims appended hereto.

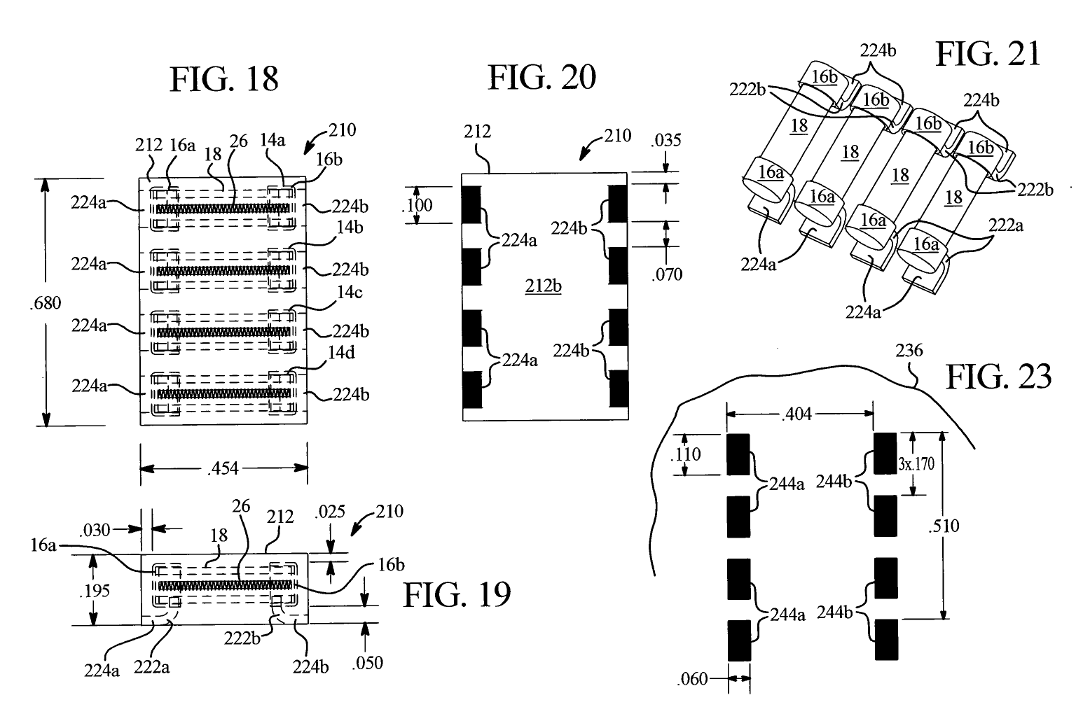

Referring now to to FIGS. 18 to 23, a further embodiment of a leadless circuit protection device is illustrated by device 210. It should be appreciated that the dimensions shown in connection with FIGS. 18 to 20 are for purposes of example only and in no way are intended to limit the scope and spirit of the claims appended hereto. The dimensions in inches highlight the compact nature of device 210, which houses overcurrent protection components capable of protecting for example a four line circuit provided on a PCB, for example.

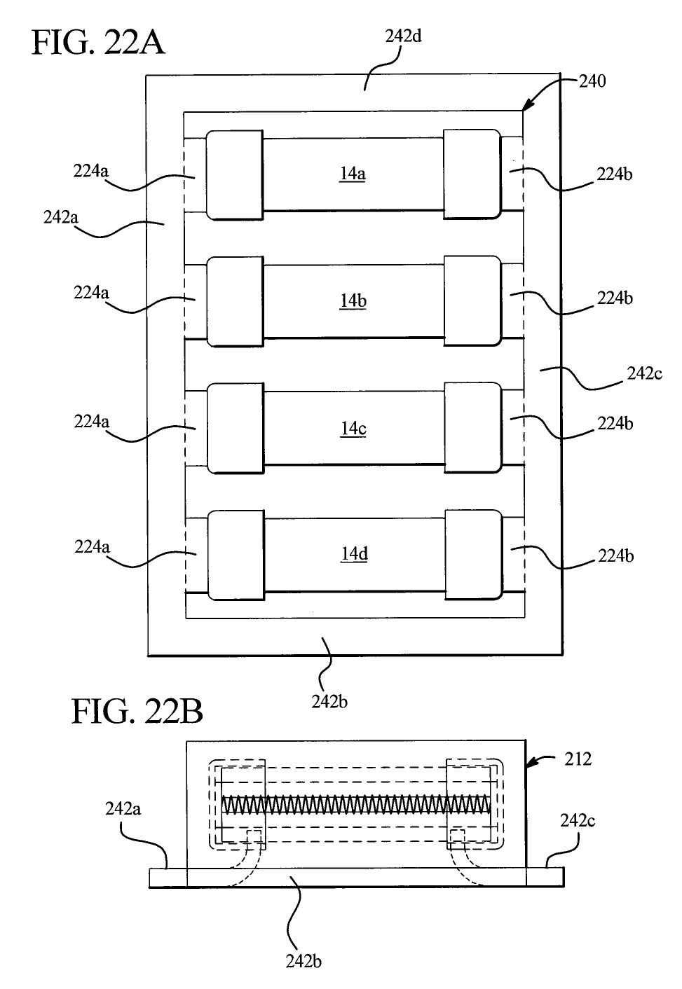

As seen in FIGS. 18 to 20, device 210 includes a protective and insulative housing 212. Insulative housing 212 shown also in connection with FIGS. 22A and 22B is molded in one embodiment about the overcurrent protection components. In the illustrated embodiment, terminal portions of conductors extending from the overcurrent protection components extend through housing 212 and reside at least substantially flush with an outer surface (e.g., bottom surface 212b seen in FIG. 19) of housing 212. Those terminal portions are configured to be soldered to a corresponding pad layout of the PCB (e.g., FIG. 23) via a reflow soldering process for example.

Housing 212 as before holds the components in place without the need for housing 212 or the conductors therein to have specially molded or machined snaps or press-fitting apparatuses. Device 210 may be solid or substantially solid, wherein the material of housing 212 fills the voids between the outer surfaces of housing 212 and the enclosed overcurrent components and associated conductors. Alternatively, housing 212 may define one or more air-gap between the outer surfaces of housing 212 and the overcurrent protection components. Here, housing 212 is configured to mechanically engage enough of the components and conductors to hold the components firmly in place.

Housing 212 is made of any of the materials described above for housing 12. Housing 212 in one preferred embodiment is rigid or semi-rigid. Housing 212 in an alternative embodiment includes an insulative protective coating or encapsulating material, such as a resin coating.

As seen in FIGS. 18 and 19, device 210 includes four separate structures with four separate overcurrent protection components 14a to 14d. The four separate structures are shown alone in the perspective view in FIG. 21. As illustrated, the separate structures make efficient use of available terminal location space along the bottom 212b of housing 212. In the illustrated embodiment, the overcurrent protection components are again fuses, such as a Pico® fuse manufactured by the assignee of the present invention. Any of the alternative devices listed above for overcurrent protection components 14a and 14b can be used for components 14a to 14d of device 110.

Each fuse 14a to 14d includes first and second endcaps 16a and 16b, insulative body 18 and fuse element 26 as described above (including all alternative embodiments) for fuses 14a to 14d of device 10. Fuse element 26 operates as described above. Upon a short circuit condition (total peak current exceeds a rated peak current) and/or an overload condition (total I²R or let-through energy exceeds a rated I²R energy) element 26 opens, which opens a protected signal line connected to the respective terminals 224a and 224b.

Elements 26 of overcurrent protection components 14a to 14d of device 210 may have any suitable rating, such as about ½ to about 2 amperes. The ratings for elements 26 of the different fuses of device 210 may each be the same, different or any combination thereof. In the illustrated embodiment, overcurrent protection components 14a to 14d are not resettable. In an alternative embodiment, overcurrent protection components 14a to 14d are resettable, such as any of the resettable overcurrent devices listed above.

As seen best in FIG. 19, end caps 16a and 16b are connected electrically and physically in an embodiment to conductors 222a and 222b, respectively. Conductors 222a and 222b are made of any suitable conductive material, such as any of those listed for conductors 22a and 22b. Conductors 222a and 222b in an embodiment are press-fitted onto, integral with and/or soldered respectively to end caps 16a and 16b. Alternatively, conductors 222a and 222b are machined or etched according to the teachings of leadframe 150 of FIGS. 17A to 17C.

As seen best in FIG. 19, a portion of conductors 222a and 222b is enclosed within housing 212. Whether or not housing 212 is solid throughout device 210 (except for the components and conductors), housing 212 in one preferred embodiment is molded around conductors 222a and 222b for each of fuses 14a to 14d of device 210. Housing 212 is thereby fixed around conductors 222a and 222b so that housing 212 holds the fuses and corresponding conductors in place firmly.

As seen in FIG. 19, terminal portions 224a and 224b extend from each of conductors 222a and 222b, respectively. Terminal portions 224a and 224b extend through housing 212 and in an embodiment reside at least substantially flush with a bottom surface 212b of housing 212. The contour of device 210 can be at least substantially smooth, as shown in connection with FIGS. 18 to 20. Terminal portions 224a and 224b can alternatively extend slightly below bottom surface 212b of housing 212 as described above.

Device 210, unlike devices 10 and 110, provides overcurrent protection only to the circuitry to which device 110 is connected. The devices collectively illustrate that circuit protection can be mixed and matched as desired, both in terms of type and rating. Corresponding conductors and terminals can be configured as needed for a particular application. The leadframe and molding process aids in readily manufacturing the disclosed examples.

Referring now to FIGS. 22A and 22B, steps in the manufacturing process of device 210 are illustrated. FIG. 22A shows that the fuse structures are formed initially on or via a leadframe 240. For reference, overcurrent protection components 14a to 14d are illustrated. Also, terminals 224a and 224b for each fuse 14a to 14d are shown for reference.

As illustrated, leadframe 240 includes members 242a, 242b, 242c and 242d. Frame members 242a to 242d are formed integrally with terminals 224a and 224b and their associated conductors 222a and 222b, respectively, for each fuse 14a to 14d. The integral structure sets the spacing for the various conductors and components of device 210. Leadframe 240 is formed as described above.

In one embodiment, components 14a to 14d are connected electrically to leadframe 140. Afterward, housing 212 is molded over the components 14a to 14d and portions of conductors 222a and 222b. Terminals 124a and 124b extend through housing 212 as discussed above.

Frame members 242a, 242b, 242c and 242d are removed or cut away from the subassembly shown in FIG. 22B to separate the different terminal portions and components electrically, while leaving the components and terminal portions in proper relative positioning. As seen in FIG. 22A, frame member 242a is removed from terminals 224a and 222b along the dashed lines, separating the terminals. Frame member 242c is separated from terminals terminals 224a and 222b along the dashed line, separating the terminals.

Referring now to FIG. 23, an embodiment of a pad layout for device 210 is illustrated. The dimensions shown in connection with FIG. 23 are for purposes of example only and in no way are intended to limit the scope and spirit of the claims appended hereto. The pad layout for pads 244a and 244b is provided on PCB 236 via any suitable process, such as photoetching. Pads 244a and 244b in an embodiment are copper. Terminal portions 224a and 224b are soldered respectively to pads 244a and 244b via any suitable soldering process, such as reflow soldering.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A circuit protection device comprising:
a fuse placed in electrical communication with first and second conductors;
an overvoltage protection component placed in electrical communication with the first conductor and a third conductor; and
an insulative housing enclosing the fuse, overvoltage protection component and portions of the first, second and third conductors, the first and second conductors including first and second terminal portions, respectively, that extend through the housing and reside at least substantially flush with an outer surface of the housing.

2. The circuit protection device of claim 1, wherein the housing includes at least one characteristic selected from the group consisting of: (i) being injection molded; (ii) being plastic; and (iii) having a melting temperature capable of withstanding at least one of a wave and reflow soldering process.

3. The circuit protection device of claim 1, wherein the fuse includes a pair of end caps, an insulative housing between the end caps and an element placed in electrical communication with the end caps.

4. The circuit protection device of claim 1, wherein the overvoltage protection component is selected from the group consisting of: a two-terminal protection thyristor, a varistor, a polymer based voltage variable material and a gas-filled tube arrester.

5. The circuit protection device of claim 1, wherein at least one of the first and second conductors is made of at least one material selected from the group consisting of: copper, tin, nickel, gold, silver, alloys thereof and any combinations thereof.

6. The circuit protection device of claim 1, wherein the third conductor is: (i) placed in communication with or (ii) integral with a ground conductor.

7. The circuit protection device of claim 6, wherein the third conductor has at least one characteristic selected from the group consisting of: (i) being enclosed entirely within the housing, (ii) being disposed on a first side of the overvoltage protection component, the opposite side of the overvoltage protection component disposed on the first conductor; (iii) being disposed on a first side of the overvoltage protection component, the opposite side of the overvoltage protection component disposed on the ground conductor; (iv) the overvoltage protection component being a first such device, the third conductor being in electrical communication with at least one of a second and third overvoltage device; and (v) the fuse being a first fuse, the third terminal being in electrical communication with a second fuse.

8. The circuit protection device of claim 7, wherein the first overvoltage protection component is disposed on the first conductor and the second overvoltage protection component is disposed on the ground conductor.

9. The current protection device of claim 8, wherein the third overvoltage protection component is disposed on a fifth conductor.

10. The circuit protection device of claim 9, wherein the fifth conductor includes at least one characteristic selected from the group consisting of: (i) being in electrical communication with the second fuse; (ii) being in communication with the third conductor; and (iii) including a terminal portion that extends through the housing and resides at least substantially flush with the outer surface of the housing.

11. The circuit protection device of claim 1, wherein the overvoltage protection component is disposed on one of the first conductor and a ground conductor.

12. The circuit protection device of claim 1, wherein the fuse, overvoltage protection component and conductors form a first assembly, and which includes a second assembly, the second assembly including
a fuse placed in electrical communication with first and second conductors, and
an overvoltage protection component placed in electrical communication with the first conductor and a third conductor.

13. The circuit protection device of claim 12, wherein the housing encapsulates the second assembly except for first and second terminal portions of the first and second conductors, respectively, that extend through the housing and reside at least substantially flush with an outer surface of the housing.

14. The circuit protection device of claim 12, wherein the third conductors of the first and second assemblies are coupled physically to their respective first and second overvoltage protection components.

15. The circuit protection device of claim 14, wherein the third conductor is placed in electrical communication with a third overvoltage protection component, the third overvoltage protection component in electrical communication with a ground terminal.

16. The circuit protection device of claim 12, which includes at least one assembly, additional to the first and second assemblies, the additional at least one assembly including a fuse and an overvoltage protection component located within the housing.

17. The circuit protection device of claim 12, wherein the third conductors of the first and second assemblies (i) extend to first and second ground terminals, respectively, or (ii) are placed in electrical communication with first and second ground terminals, respectively.

18. The circuit protection device of claim 1, wherein at least one of the first and second conductors includes a raised portion in electrical communication with the fuse, the raised portion formed by etching or machining.

19. A circuit protection device comprising:
a first fuse placed in electrical communication with a first pair of conductors;
a second fuse placed in electrical communication with a second pair of conductors;
a first overvoltage protection component placed in electrical communication with one of the conductors of the first pair;
a second overvoltage protection component placed in electrical communication with one of the conductors of the second pair;
a bridge conductor placed in electrical communications with the first and second overvoltage protection component; and
an insulative housing enclosing the first and second fuses, the first and second overvoltage protection components and portions of the first and second pairs of conductors, the conductors of the first and second pairs each including a terminal portion extending through the housing.

20. The circuit protection device of claim 19, wherein the terminal portions reside at least substantially flush with an outer surface of the housing.

21. The circuit protection device of claim 19, wherein the overvoltage protection component is selected from the group consisting of: a two-terminal protection thyristor, a varistor, a polymer based voltage variable material and a gas-filled tube arrester.

22. The circuit protection device of claim 19, wherein the bridge conductor includes at least one characteristic selected from the group consisting of: (i) being placed in electrical communication with a third overvoltage protection component; (ii) being in electrical communication with a ground conductor; and (iii) extending to a ground terminal.

23. The circuit protection device of claim 19, wherein the first fuse, second fuse, first overvoltage protection component, second overvoltage protection component, first conductor pair, second conductor pair and bridge conductor form a first assembly, and which includes at least one like second assembly located at least partially within the housing.

24. The circuit protection device of claim 19, wherein at least a portion of the bridge conductor includes a raised portion in electrical communication with one of the first and second overvoltage protection components, the raised portion including at least one machined or etched edge.

25. A circuit protection device comprising:
a first fuse placed in electrical communication with a first pair of conductors;
a second fuse placed in electrical communication with a second pair of conductor;
a first overvoltage protection component placed in electrical communication with one of the conductors of the first pair;
a second overvoltage protection component placed in electrical communication with one of the conductors of the second pair;
a first and second ground conductor placed in electrical communication with the first and second overvoltage protection components, respectively; and
an insulative housing enclosing the first and second fuses, the first and second overvoltage protection components and portions of the first and second pairs of conductors, the conductors of the first and second pairs each including a terminal portion extending through the housing.

26. The circuit protection device of claim 25, wherein the terminal portions reside at least substantially flush with an outer surface of the housing.

27. The circuit protection device of claim 25, wherein the overvoltage protection component is selected from the group consisting of: a two-terminal protection thyristor, a varistor, a polymer based voltage variable material and a gas-filled tube arrester.

28. The circuit protection device of claim 25, wherein the first and second ground conductors each include terminal portions extending though the housing.

29. The circuit protection device of claim 25, wherein the first fuse, second fuse, first overvoltage protection component, second overvoltage protection component, first conductor pair, second conductor pair and first and second ground conductors form a first assembly, and which includes at least one like second assembly located at least partially within the housing.

30. The circuit protection device of claim 25, wherein at least one of the first and second ground conductors includes a raised portion in electrical communication with the fuse, the raised portion formed by etching or machining.

31. A circuit protection device comprising:
a first fuse placed is electrical communication with a first pair of conductors;
a second fuse placed in electrical communication with a second pair of conductors; and
an insulative housing enclosing the first and second fuses and portions of the first and second pairs of conductors, the conductors of the first and second pairs each including a terminal portion that extends through the housing and resides at least substantially flush with an outer surface of the housing.

32. The circuit protection device of claim 28, which includes at least one additional fuse enclosed within the housing, the at least one additional fuse in electrical communication with at least one additional pair of conductors.

33. The circuit protection device of claim 28, wherein at least one of the first and second fuses includes a pair of end caps, an insulative housing between the end caps and an element placed in electrical communication with the end caps.

34. A circuit protection device comprising;
a housing;
first and second conductors located in the housing, the conductors each having first and second raised portions;
a fuse having first and second end caps, the first end cap placed between the first and second raised portions of the first conductor, the second end cap placed between the first and second raised portions of the second conductor; and
an overvoltage protection component located in the housing and in electrical communication with one of the first and second conductors.

35. The circuit protection device of claim 34, wherein at least one of the first and second conductors extends through the housing to form a terminal.

36. The circuit protection device of claim 34, wherein the first and second conductors are formed via separation from a leadframe, the leadframe separated from an array of leadframes.
